(19) United States
(12) Patent Application Publication
(10) Pub. No.: US 2003/0192442 A1
(43) Pub. Date: Oct. 16, 2003

(54) Dosing system for inking up rollers in a printing machine

(76) Inventors: Hubert Zschetzsche, Offenbach (DE); Peter Hummel, Offenbach (DE); Robert Ortner, Alzenau (DE)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(21) Appl. No.: 10/258,781

(22) PCT Filed: Apr. 12, 2001
(86) PCT No.: PCT/EP01/04229

(30) Foreign Application Priority Data
Apr. 26, 2000 (DE) 10020510.0

(51) Int. Cl. B41F 31/04

(52) U.S. Cl. 101/350.1

(57) ABSTRACT

The invention concerns a metering system for the inking of rollers in a printing machine.

The task of the invention is based on creating a metering system that achieves, with minimum expense, a uniform, stable ink guidance on a roller surface and noticeably improves the print quality.

The task is solved in that, in the direction of rotation of a roller 1, preferably after a contact zone 10, where ink separation occurs, a plating device 12 is adjustable to the outer surface of the roller 1.

### DESCRIPTION

The invention concerns a metering system for the inking of rollers in a printing machine, with at least one roller train leading to a plate or form cylinder, wherein the rollers can be inked by means of ink or lacquer from a storage container, according to the preamble of the main claim. The invention can preferably be used in an inking unit of a printing machine with a rotating roller arranged between an ink fountain roller and a subsequent inking unit roller, particularly in a film or vibrating inking unit.

### STATE OF THE ART

A printing machine with a vibrating inking unit is known from DE 37 06 602 A1. Here, an ink fountain roller is in functional connection with an ink fountain with a metering system for the printing ink, as is known from, e.g., DE 27 11 553 A1. For printing machines with a vibrating inking unit, the printing ink is periodically removed in strips from an ink fountain roller by back and forth pendulate motion of an ink vibrating roller and fed to an inking unit roller of the subsequent roller train. Limited by the different rotational speeds of the ink fountain roller and the inking unit roller, vibrating inking units have the problem that the inking vibrating roller is delayed or accelerated with each strike (contact) to the ink fountain roller or the inking unit roller. With this striking or lifting of the vibrating roller, there is nonuniform ink guidance during the ink transport of the printing ink, in connection with an up-and-down ink separation in the contact zone of the rollers, also on the ink fountain roller or on the inking unit roller, which has a quality-reducing effect on the printing. Due to the ink separation of the printing inks between the ink fountain roller and the ink vibrating roller, as well as between the ink vibrating roller and the subsequent inking unit roller, uneven surface structures are formed for the remaining ink on the roller surfaces, which leads to reduced quality on the printing material.

From DE 38 04 204 A1, an inking unit of a printing machine with a film roller is known. Such a film roller is designed for the ink transport across a film gap (first contact zone) in contact with the ink fountain roller as well as in a second contact zone with the subsequent inking unit roller, of the subsequent roller train, so that a continuous ink transport of printing ink between the ink fountain roller and the inking unit roller of the roller train can be realized in the inking unit. In addition, an intermediate roller is arranged in contact with the film roller, wherein a doctor blade roller is arranged after this intermediate roller. In contact with the doctor blade roller there is an adjustable doctor blade, and the doctor blade can be set or adjusted depending on the subject or at intervals on the doctor blade roller. The printing ink removed by the doctor blade roller is then led back into the ink fountain. This film inking unit is used for minimizing the minimum ink amount by removing a portion of ink from an inking unit and is relatively expensive due to the additional use of rollers (intermediate roller, doctor blade roller). In the contact zones of the ink fountain roller and film roller and film roller and subsequent inking unit roller, there occurs, analogous to the described vibrating inking unit, an ink separation of the printing ink per contact zone, so that also for film inking units, uneven surface structures are formed for the ink on the roller surfaces, which leads to reduced printing quality on the printing material.

Furthermore, from DE 196 09 946 A1 a printing machine with an applicator for inking a roller of an inking unit is known. The applicator consists of a storage container with ink or lacquer or a comparable medium, which is in functional connection with a metering roller. The metering roller is in friction contact with a drivable roller for ink transfer and thus forms a contact zone in which ink or lacquer separation occurs.

According to DE 42 41 809 A1, a printing machine with a device for the inking of rollers is known, which leads ink from a storage container under compressed air according to zones in the axial direction of the rollers onto their outer surfaces. In this way, there is no contact on the side of the device with the outer surface of the associated rollers to be inked. The zone-wise deposited ink forms a different amount of ink on the outer surface of the inked roller, which exhibits an uneven surface structure for the ink.

Such an uneven surface structure for the ink on the outer surface of a roller results from pulling off of the ink, e.g., for ink emerging from a storage container and striking an outer surface, or after an ink separation process (division of the ink layer) in the contact zone of two rollers or the contact zone of a roller with a stripping system, e.g., an ink metering system.

From DE 199 38 301 A1, an inking unit for a printing machine for uniform application of ink is known. Starting from the fact that there is tension at the roller gap formed by two rollers, there results a nonuniform ink transfer. Such tension influences, e.g., the line pressure in the roller gap of two rollers, and this different line pressure effects, e.g., a nonuniform ink transfer, which appears on the printing material as an ink film that has been applied nonuniformly. For improving the ink transfer, there is at least one smoothing element that is assigned to an inking unit roller and that removes shearing forces of the ink. Preferably, the smoothing element is associated with an ink applying roller and/or an ink friction roller adjacent to the plate cylinder.

### TASK OF THE INVENTION

The task of the invention is based on creating a metering system of the type mentioned at the beginning, which achieves, with minimal expense, a uniform, stable ink guidance (or lacquer guidance) on at least one roller surface and noticeably improves the printing quality.

The task is executed according to the invention by the configuration features of the independent claim. Refinements result from the dependent claims.

It was found that on the outer surface of an ink-guiding (the term also includes a lacquer-guiding roller) roller, after the pulling off (shearing) of ink (or lacquer) in a contact zone, the ink/lacquer distribution is not uniform, in terms of across the roller width. On the roller there is an uneven surface structure of ink (lacquer), which is characterized by ink peaks or ink cones and ink valleys (or lacquer peaks, lacquer cones, lacquer valleys) on the outer surface of an ink-guiding roller.

For example, for an ink fountain roller, after the ink separation (splitting of ink layer) in a contact zone with another roller, e.g., a vibrating or film roller, through pulling off of ink/lacquer, particularly for thread-like pulling off, the ink/lacquer distribution is not uniform across the roller width, but instead there is an uneven surface structure of the remaining ink (or the remaining lacquer) on the outer surface of the ink fountain roller. This also applies to ink zones generated within an ink metering system of ink metering elements with layer thickness defined in zones, because here a pulling off of ink or lacquer also occurs as a consequence of the shearing forces separating the ink (lacquer).

A first advantage of the invention is based on the fact that for an uneven surface structure (peaks, cones, and valleys) of ink (lacquer), which results from prior pulling off of ink (lacquer), at least one ink-guiding (or lacquer-guiding) roller is assigned to at least one plating device at its periphery. The plating device effects a shape change (plastic shaping) of the ink peaks or ink cones and ink valleys (or lacquer peaks, lacquer cones, lacquer valleys) within the surface structure of the ink (or lacquer). The shape change represents a micro-conversion of the surface structure of the ink (lacquer). For such a shape change of the ink (lacquer), the ink peaks or ink cones (lacquer peaks, lacquer cons) slide into the ink valleys (lacquer valleys), i.e., smoothing processes are performed within the ink layer on the ink texture (lacquer texture), which effect plastic shaping, so that an approximately even surface structure can be achieved with a defined layer thickness.

The plastic shaping by the plating device is advantageous because the ink or the lacquer is not exposed to a shearing effect (shearing or dispersion effect). A shearing effect leads, in turn, to undesired pulling off of ink or lacquer and thus to uneven surface structure.

The relatively even surface structure of ink (or lacquer) achieved by the plating device has the effect that ink/lacquer density variations can be clearly reduced on the printing material, so that the printing/gloss or reflective quality is noticeably improved. As a result, there is an even surface structure of the ink or remaining ink or lacquer on the outer surface of the corresponding roller across the roller width before the roller comes in contact with a subsequent contact zone (e.g., a gap position).

With such a plating device, this uneven surface structure of the ink or remaining ink or lacquer is clearly leveled in an advantageous way on the associated roller, e.g., the ink fountain roller, so that a uniform surface structure of the ink or remaining ink or lacquer can be achieved for a uniform, stable ink/lacquer guidance in the roller train.

The use of a plating device, particularly on an ink fountain roller, is advantageous because a clearly reduced amount of, e.g., printing ink in the metering gap (gap between ink metering system, e.g., ink valves, and ink fountain roller) is passed through the metering gap.

It is likewise an advantage that particularly the parameters changing during the printing process, such as, e.g., printing speed, temperature, ink amount, hydrodynamic pressure in the ink fountain, as well as the viscosity of the printing ink or the lacquer, are noticeably reduced as possible interference variables by the use of a plating device according to the invention.

Another advantage is that the plating device according to the invention is not limited to one ink fountain roller. The arrangement of plating devices can also be realized for other ink-guiding (including lacquer-guiding) rollers of an inking unit. Here, preferably at least one plating device is assigned to each roller. Alternatively, several plating devices can also be arranged for one roller.

It is likewise advantageous if the surfaces of the ink or remaining ink or lacquer, which are leveled uniformly by the plating device, lead to uniform ratios for the subsequent ink/lacquer separation (in the ink metering system) in the ink fountain or to uniform separation ratios between adjacent rollers (contact zones) themselves, which noticeably improves the print quality. With the leveling of ink or lacquer on the outer surface of a roller, a homogenous ink layer is created, which can be more easily metered. In this way, a smaller distance of the ink metering elements of the ink metering system to the roller for the same ink thickness (lacquer thickness) can be realized and a continuous ink flow achieved.

Furthermore, the inking unit according to the invention reduces by a considerable extent the interference of the ink flow through the independently controlled rpms and, if necessary, the direction of rotation of the roller, e.g., of the film roller, which can achieve better adaptation of the ink flow to the printing speed.

Furthermore, according to the geometry of the roller train in the inking unit, there is the possibility of reducing the number of inking rollers. Therefore, a uniform surface structure of the remaining ink or the remaining lacquer on a roller can be achieved for fewer gap points in order to achieve a defined layer thickness of the ink film on the plate cylinder. In this way, the roller train can also be shortened.

The plating device is used for creating a relatively even surface structure on the outer surface of a corresponding ink or lacquer-guiding roller. In the region of the plating device, a pulling off/shearing of ink or lacquer is to be prevented at the outer surface of the corresponding roller, because otherwise this leads, in turn, to uneven surface structures. The configuration of the plating device is not limited to one or more mechanical plating device(s) with one or more plating element(s). For example, for achieving an even surface structure, an air doctor blade that introduces compressed or blown air onto the outer surface of the ink/lacquer guiding roller or an ultrasonic system directed onto the ink can be used in order to achieve plastic shaping.

### EXAMPLES

The invention is to be explained in more detail with an embodiment. Here, shown schematically are:

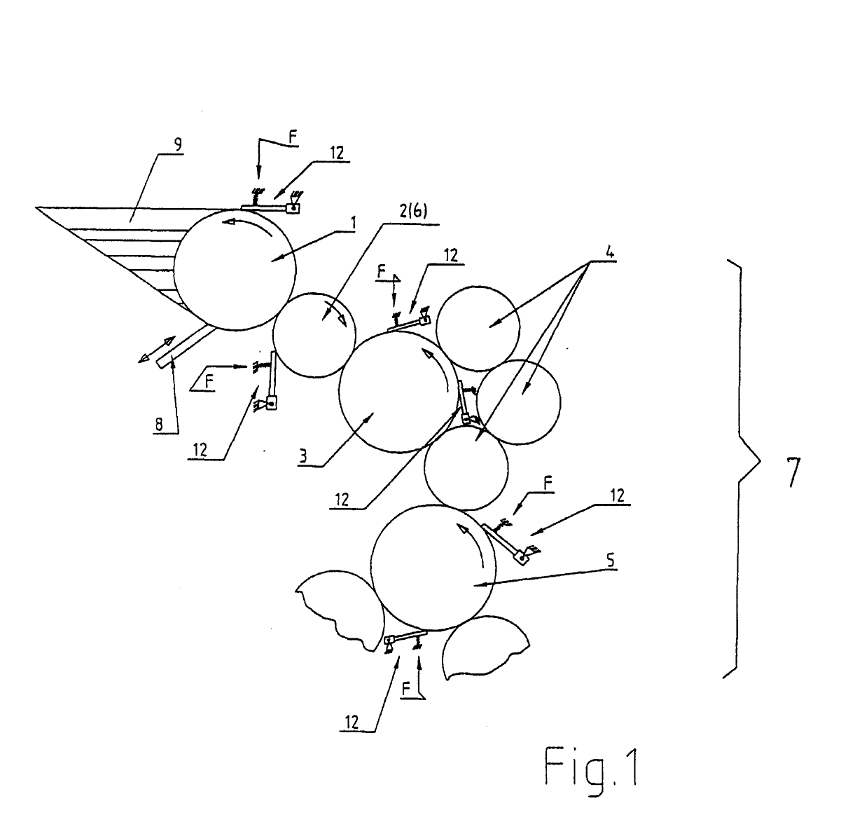

FIG. 1, the arrangement of a metering system for inking an inking unit,

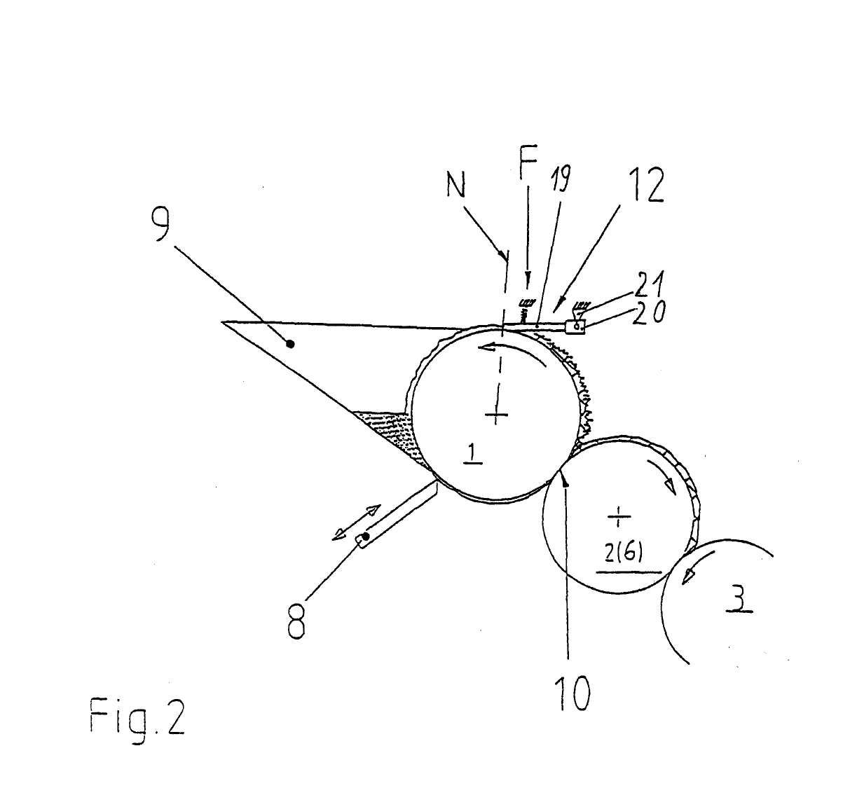

FIG. 2, an ink metering system in functional connection with an ink fountain roller,

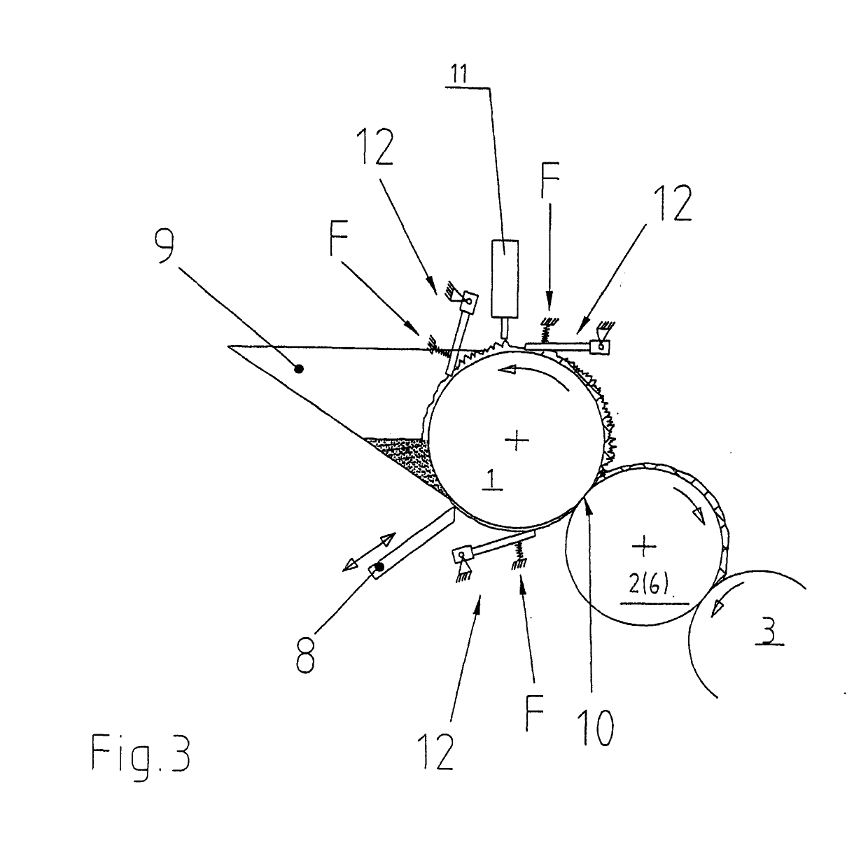

FIG. 3, a metering system with an ink fountain roller and an ink dispensing device,

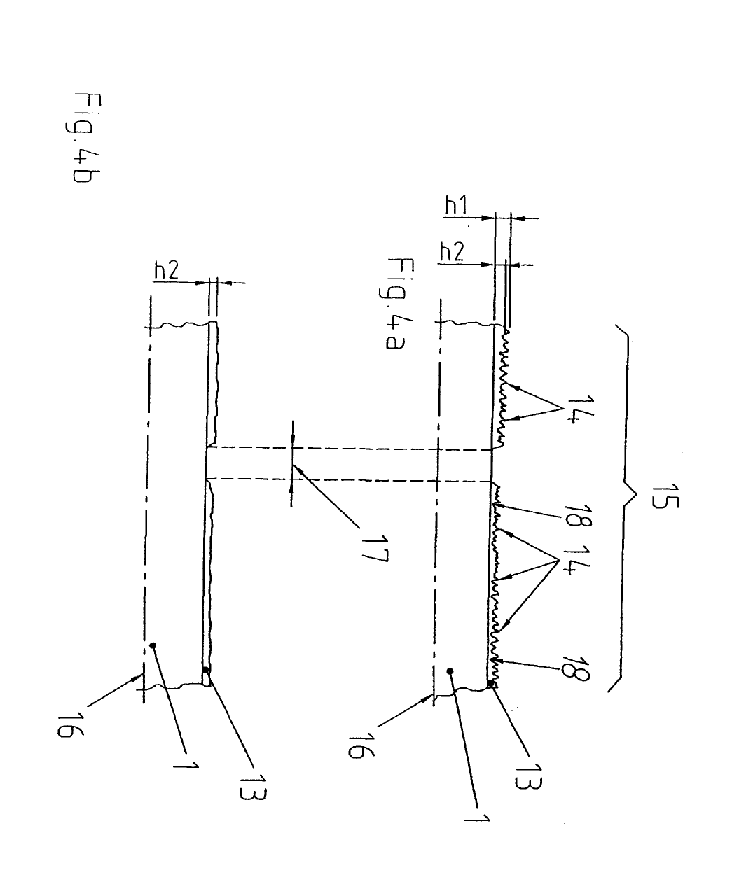

FIGS. 4a, b, representations of surface structures.

The offset printing press of a sheet-fed rotational printing machine essentially consists of an inking unit with an ink fountain roller 1 in functional connection with an ink fountain 9 with an ink metering system 8, e.g., ink valves, furthermore a vibrating roller 2 or a film roller 6 and an inking unit roller 3 configured as a first ink friction roller (can be driven with rotating and transverse axial motion) of a subsequent roller train 7. This roller train 7 leads to the plate cylinder (or form cylinder) and has, in a known way, a plurality of rollers, of which, e.g., the second ink friction roller 5 (can be driven with rotating and transverse, axial motion) is designed with intermediate transfer rollers 4 (FIG. 1).

A plating device 12 is assigned to at least one roller (1-6) of the inking unit adjacent to its outer surface after a contact zone 10, where a pulling off or separation of ink occurs, and this plating device can be set, and preferably adjusted, to the outer surface of the roller (1-6). The plating device 12 thus extends essentially parallel across a full roller width 15.

Preferably, the plating device 12 can be set by means of a force F to the outer surface of the corresponding roller (roller 1-6). By means of the plating device 12, preferably a uniform surface pressure can be applied across the roller width 15 (roller 1-6) on the ink or remaining ink, alternatively on the outer surface of the roller 1-6 guiding the lacquer.

In a preferred refinement, in the direction of rotation of the roller 1-6, the plating device 12 can be set in its direction to form a tangent or secant to the outer surface of the roller 1-6.

Such a plating device 12 is preferably formed by a plating element 19 extending across the roller width 15, preferably set at a positive tangent in the direction of rotation of the roller 1-6, which is mounted so that it can be detached in a support 20 and extends in the axial direction across the entire roller width 15 parallel to the outer surface of the roller 1-6. The support 20 of the plating element 19 is preferably supported on two sides by a hinge 21 mounted on a frame, preferably supported so that it can pivot about the axis of the hinge 21.

In a preferred refinement, the plating element 19 or the plating device 12 is in functional connection by means of at least one, preferably adjustable compression spring mounted to the frame. In particular, the plating element 19 is preferably loaded by a force F. Alternatively, instead of the compression spring, a working cylinder that can be operated, e.g., pneumatically, or other means generating the force F can be used. Likewise, according to the arrangement of the plating element 19, its own weight can be used with the associated roller 1-6 in functional connection, without generating a shearing effect on the outer surface or the remaining ink (remaining lacquer). In another refinement, the plating device 12 is also arranged at a minimum distance to the outer surface of the roller 1-6 in order to achieve an even surface structure.

The plating element 19 ends with its free end preferably on a surface normal N (tangent point or secant point) of the corresponding roller 1-6. In another refinement, the plating element 19 leads tangentially in the direction of rotation of the roller 1-6 slightly beyond its outer surface, which prevents pulling off of ink or lacquer.

Preferably, in the present example the plating device 12 according to the invention is adjacent at least to the ink fountain roller 1 (e.g., FIG. 2), which can be inked, e.g., with an offset printing ink. Here, the plating device 12 is arranged so that it can be adjusted tangentially in the direction of rotation of the ink fountain roller 1 with shaft 16 according to a contact zone 10 with an adjacent vibrating roller 2 or film roller 6 and before the ink metering system 8. This plating device 12 levels the uneven surface structure of the remaining ink remaining on the outer surface of the ink fountain roller 1 after the contact zone 10 of the vibrating roller 2 or film roller 6, before the remaining ink comes in renewed contact with the (new) ink in the ink fountain 9 and the ink metering system 8.

Thus, in the direction of rotation of the ink fountain roller 1 there is already a leveled surface structure of ink on the outer surface of the ink fountain roller 1 before the ink metering system 8 and possible ink passage in the region of the ink metering system 8 is noticeably reduced. In addition, by the use of a plating device 8 already at the ink fountain roller 1, possible ink thickness variations on the printing material can be noticeably reduced. The even surface structure leads, in turn, to always the same ratios in a contact zone for the subsequent metering of printing ink in the ink fountain 9 with an ink metering system 8 or to the same ink separation ratios in a contact zone 10 of two rollers, e.g., of ink fountain roller 1 and vibrating roller 2.

The use of a plating device 12 is not limited to an ink fountain roller 1. The arrangement of plating devices 12 can also be realized at other rollers 2-6 of the inking unit. Preferably, the arrangement of other plating devices 12 (in addition to at least one plating device 12 at the ink fountain roller) can be realized for rollers 2-6 of the inking unit, which are arranged at a distance from the plate cylinder. This is because, due to these rollers, e.g., in the region limited by the film or vibrating roller 6, 2 and the second ink friction roller 5, a large layer thickness is transferred and level surface structures generated by single or several plating devices 12 reduce as much as possible ink thickness variations on the printing material.

Under this aspect, in addition to the arrangement of the plating device 12 at the ink fountain roller 1, an arrangement of a plating device 12, e.g., at the offset roller 2 or the film roller 6, can also be realized. In the direction of rotation of the offset or film roller 2, 6, after the contact zone 10 with the ink fountain roller 1 and before the contact zone 10 of the subsequent inking unit roller 3 (first ink friction roller), there is, preferably tangentially in the direction of rotation of the offset/film roller 2, 6, another adjustable plating device 12.

In another refinement, in addition to the arrangement of the plating device 12, there is also another plating device 12 of the inking unit roller 3 assigned at least to the ink fountain roller 1 and in the direction of rotation of this inking unit roller 3 after the contact zone 10 with the vibrating roller 2 or film roller 6 and before the contact zone 10 of at least one roller arranged after the inking unit roller 3, there is, e.g., at least one transfer roller 4, of the inking unit that can preferably be adjusted tangentially in the direction of rotation of the inking unit roller 3.

In another refinement, in addition to the arrangement of the plating device 12 assigned at least to the ink fountain roller 1, there is also another plating device 12 of at least one drivable roller, preferably of the second ink friction roller 5 of the inking unit. In the direction of rotation of the ink friction roller 5 after their contact zone 10 with a directly adjacent roller, preferably a transfer roller 4, and preferably before the contact zone 10 with another directly adjacent roller of the inking unit, there is at least one other plating device 12 that can be adjusted preferably tangentially in the direction of rotation of the corresponding drivable ink friction roller 5.

The effect will be explained first with the refinement shown in FIG. 2. In the ink fountain 9, there is a storage container of printing ink, and an ink fountain roller 1 rotates into this container in its direction of rotation and is inked. In the following contact zone 10 in the direction of rotation, there is a pulling off of printing ink done by the ink metering device 8 and the inked ink fountain roller 1 leads the remaining printing ink to the next contact zone 10. This contact zone 10 is formed by the ink fountain roller 1 and the vibrating roller 2 (alternatively, the film roller 7). In this contact zone 10, ink separation occurs, so that an ink layer 13 remains in defined layer thickness as the remaining ink on the ink fountain roller 1 and an ink film of defined layer thickness is transferred onto the vibrating roller 2 or film roller 6.

After the contact zone 10, according to FIG. 4a, there is the remaining ink (ink layer 13) as an uneven surface structure in the form of ink peaks, ink cones 14 and also ink valleys 18 on the outer surface of the ink fountain roller 1. FIG. 4a shows this surface structure in the roller width 15 with a first layer thickness h₁ and, e.g., an ink zone 17. The ink fountain roller 1 now fits in the direction of rotation the plating device 12, which effects the form change (plastic shaping) of the ink peaks, ink cones 14, and also ink valleys 18, and, as a result, according to FIG. 4, there is a relatively even surface structure with a second layer thickness h₂. In this way, the ratio of layer thickness is always: h₁>h₂. The adjusted ink profile with, e.g., the ink zone 17, remains essentially preserved.

The invention is not restricted to the present embodiment.

The object of the invention starts from the observation that, in the direction of rotation of an inked roller 1-6 before a contact zone 10, where pulling off or separation of ink occurs, the ink or the remaining ink or also lacquer is leveled on the outer surface of this (these) roller(s) 1-6 by means of at least one plating device 12. According to each configuration of the inking unit, a leveling of the ink or remaining ink or lacquer can be performed also before the first contact zone 10 where ink separation occurs.

For example, this is the case according to FIG. 3, when ink/lacquer is fed by pulling off from a storage container of an ink dispensing device 11, e.g., of an ink cartridge, directly onto the outer surface of the associated roller, preferably the ink fountain roller 1, i.e., the ink fountain roller 1 is inked, and in the direction of rotation of roller 1, an ink metering system 8, in which separation of ink (lacquer) occurs, is connected. In this configuration, the plating device 12 is adjustable in the direction of rotation of the ink fountain roller 1 after the ink dispensing device 11 and before the ink metering system 8 to the ink fountain roller 1.

Furthermore, in the direction of rotation of the inked ink fountain roller 1 (and/or other rollers 2-5) after the first contact zone 10, where pulling off or separation of ink occurs, the uneven surface structure of ink or remaining ink (lacquer, remaining lacquer) can be leveled on the outer surface of this ink fountain roller 1 by means of plating device 12 and subsequently the surface structure leveled on the outer surface can be fed to a second contact zone 10, where pulling off of ink (lacquer) or renewed ink/lacquer separation occurs.

In a refinement, in the direction of rotation at least one inked roller 1-6 after the second contact zone 10, where a pulling off/separation of ink occurs, and before the first contact zone 10, where a pulling off or separation of ink occurs, the remaining ink or the remaining lacquer is leveled on the outer surface of this roller (1-6).

If the roller 1-6 is in contact at several contact points 10, where pulling off of the ink or the lacquer occurs, then at least one, preferably also several, plating devices 12 are assigned to the corresponding roller 1-6 in the direction of rotation of the corresponding roller 1-6 before the next contact point 10.

For the arrangement of at least one plating device 12 in the region of the ink fountain roller 1 in the direction of rotation before the ink metering system 8, the plating device 12 can also be immersed in the ink fountain 9.

The plating system 12 is preferably arranged so that it can be set and adjusted to each roller 1-6.

[List of reference symbols]

| | |
|---|---|
| 1 | Ink fountain roller |
| 2 | Vibrating roller |
| 3 | Inking unit roller (first ink friction roller) |
| 4 | Transfer roller |
| 5 | Second ink friction roller |
| 6 | Film roller |
| 7 | Roller train |
| 8 | Ink metering system |
| 9 | Ink fountain |
| 10 | Contact zone |
| 11 | Ink dispensing device |
| 12 | Plating device |
| 13 | Ink layer |
| 14 | Ink peak, ink cone |
| 15 | Roller width |
| 16 | Axle |
| 17 | Ink zone |
| 18 | Ink valley |
| 19 | Plating element |
| 20 | Support |
| 21 | Hinge |
| F | Force |
| h₁ | First layer thickness |
| h₂ | Second layer thickness |
| N | Normal to surface |

1. Metering system for the inking of rollers in a printing machine with at least one roller train leading to a plate or form cylinder, wherein a roller can be inked by means of ink or lacquer from a storage container, characterized in that in the direction of rotation of a roller (1-6), after a contact zone (10), where pulling off of ink/lacquer or ink/lacquer separation occurs, there is a plating device (12) that is adjustable parallel to the outer surface of the roller (1-6).

2. Metering system according to claim 1, characterized in that in the direction of rotation of the roller (1-6), before a contact zone (10), where ink/lacquer separation occurs, there is a plating device (12) that is adjustable parallel to the outer surface of the roller (15-21).

3. Metering system according to at least claim 1, characterized in that in the direction of rotation of the roller (1-6), the plating device (12) is adjustable in its direction to form a tangent or secant to the outer surface of the roller (1-6).

4. Metering system according to at least claim 1, characterized in that the plating device (12) is assigned to an ink fountain roller (1) and is adjustable to the ink fountain roller (1) after the contact zone (10) with a vibrating roller (2) or a film roller (6) and before an ink metering system (8) in the direction of rotation of the ink fountain roller (1).

5. Metering system according to at least claim 1, characterized in that the plating device (12) is assigned to the vibrating roller (2) or the film roller (6) and is adjustable in the direction of rotation of the vibrating/film roller (2, 6) after the contact zone (10) with the ink fountain roller (1) and before the contact zone (10) of the subsequent inking unit roller (3).

6. Metering system according to at least claim 1, characterized in that the plating device (12) is assigned to the inking unit roller (3) and is adjustable in the direction of rotation of the inking unit roller (3) after the contact zone (10) with the vibrating roller (2) or film roller (6) and before the contact zone (10) of a roller (4) arranged directly after the inking unit roller (3) of the roller train (7).

7. Metering system according to at least claim 1, characterized in that the plating device (12) is assigned to at least one drivable roller (3, 5) of the roller train (7) and is adjustable in the direction of rotation of the roller (3, 5) after the contact zone (10) with a directly adjacent roller of the roller train (7) and before the contact zone (10) with another directly adjacent roller of the roller train (7).

8. Metering system according to at least claim 1, characterized in that the plating device (12) can be set on the outer surface of the roller (1-6) by a force (F).

9. Metering system according to at least claim 1, characterized in that a uniform surface pressure can be applied across the width of the roller (1-6) by the plating device (12).

10. Metering system according to at least claim 1, characterized in that the plating device (12) has a plating element (19) in the direction of rotation of the roller (1-6), which extends across the entire roller width (15) and which is mounted so that it can be detached in a support (20).

11. Metering system according to at least claims 1 and 10, characterized in that the support (20) is mounted on two sides in a hinge (21) fixed rigidly to the frame.

12. Metering system according to at least claims 1 and 10, characterized in that the plating element (19) is in functional connection with a compression spring mounted to the frame.

13. Metering system according to at least claims 1 and 10, characterized in that a free end of the plating element (19) ends at a tangent point or secant point at the outer surface of a roller (1-6).

14. Metering system according to at least claims 1 and 10, characterized in that a free end of the plating element (19) ends at a minimum distance to the outer surface of the roller (1-6).

15. Metering system according to at least claims 1, characterized in that in the direction of rotation of roller (1-6), the plating device (12) can be adjusted in its direction to form a secant or tangent to the outer surface of the roller (1-6).
